(19) United States
(12) Patent Application Publication
(10) Pub. No.: US 2019/0334919 A1
(43) Pub. Date: Oct. 31, 2019

(54) FLEXIBLE RESOURCE ACCESS CONTROL

(71) Applicant: QUALCOMM Incorporated, San Diego, CA (US)

(72) Inventor: Vincent Pierre LE ROY, SAN DIEGO, CA (US)

(21) Appl. No.: 15/965,573

(22) Filed: Apr. 27, 2018

(51) Int. Cl. H04L 29/06; G06F 21/60; H04L 12/24; G06F 9/52

(52) U.S. Cl. CPC H04L 63/105; G06F 21/604; G06F 2221/2141; H04L 41/0893; G06F 9/526; H04L 63/20

(57) ABSTRACT

One feature pertains to a device that includes memory circuits having resource groups and access control circuitry. The access control circuitry establishes a tiered resource group access control scheme where security and access control properties of each resource group are managed by at least one of a hard governor execution environment or at least one soft governor execution environment. The access control circuitry also enforces access permissions of each resource group set by at least one of the hard governor execution environment or the at least one soft governor execution environment of each resource group.

### BACKGROUND

### Field

Various aspects of the present disclosure relate to access control of an electronic device's resources, and in particular, to systems, devices, and methods for flexible, multi-level resource governorship for managing security and access control properties of an electronic device's resource groups.

### Background

An electronic device may have a myriad of memory resource groups. Such resource groups may be accessed by different execution environments such as user applications, higher level operating systems, and hardware. In some resource group access control schemes (e.g., “conjoined” scheme), an execution environment has exclusive access control of a resource group because access permissions are hardcoded specific to that execution environment. For instance, resource groups in such a scheme are divided up into secure and non-secure resource groups. Secure resource groups are only accessible by a secure execution environment and other execution environments cannot access the secure resource groups. In other resource group access control schemes (e.g., “disjoined” scheme), a single execution environment manages the security and access control properties for a resource group and sets the access permissions of the resource group for all other execution environments.

Execution environments may also be grouped into trust domains. For example, a first set of execution environments may be part of a first trust domain and a second set of execution environments may be part of a second trust domain Each trust domain has a different root of trust and prior art schemes do not allow an execution environment from the first trust domain to manage the access permissions of an execution environment from the second trust domain.

When a resource group needs to be shared between two execution environments within the same trust domain then there may be no issue of sharing the resource group since there will be an execution environment within that trust domain that has a higher level of security and access control properties that can manage the access permissions of the lower privileged execution environment. However, in multi-dimensional schemes where two execution environments belonging to different trust domains wish to share a resource then there is a problem since neither execution environment can manage the access permissions of the other since they mutually distrust one another. Moreover, in cases where management of security and access control properties of a resource is transferred from one execution environment to another execution environment in a different trust domain, a gap in security and access control property management results as the former owner relinquishes control before the new execution environment steps in. This gap in time creates a security vulnerability.

Thus, there is a need for systems, devices, and methods for managing security and access control properties of an electronic device's resource groups that, among other things, allows execution environments associated with different trust domains to share resource groups and manage access permissions of execution environments across different trust domains. Moreover, such systems, devices, and methods should also provide increased security by ensuring that management of the security and access control properties are transferred between executions environments atomically so that there are no gaps in time where the resource group is unmanaged.

### SUMMARY

One feature provides an apparatus comprising one or more memory circuits including a plurality of resource groups, access control circuitry communicatively coupled to the one or more memory circuits, the access control circuitry configured to establish a tiered resource group access control scheme where security and access control properties of each resource group of the plurality of resource groups are managed by at least one of (a) a hard governor execution environment or (b) at least one soft governor execution environment, and enforce access permissions of each resource group of the plurality of resource groups set by at least one of (c) the hard governor execution environment or (d) the at least one soft governor execution environment of each resource group. According to one aspect of the disclosure, the access control circuitry is configured to establish the tiered resource group access control scheme by being further configured to allow only one execution environment to claim hard governorship for each resource group of the plurality of resource groups. According to another aspect, an execution environment having hard governorship of a first resource group of the plurality of resource groups exclusively manages security and access control properties of the first resource group for execution environments of the apparatus.

According to one aspect of the disclosure, the access control circuitry is configured to establish the tiered resource group access control scheme by being further configured to facilitate a hard governor execution environment of a first resource group of the plurality of resource groups to grant soft governorship of the first resource group to at least a first execution environment of the apparatus. According to another aspect, the access control circuitry is further configured to facilitate the at least first execution environment having soft governorship of the first resource group to manage security and access control properties of the first resource group for execution environments of the apparatus subject to revocation of its soft governorship by the hard governor execution environment. According to yet another aspect, the access control circuitry is configured to establish the tiered resource group access control scheme by being further configured to enable a first execution environment to claim secondary soft governorship of a first resource group of a plurality of resource groups when the first resource group has at least one other execution environment serving as its soft governor.

According to one aspect, the access control circuitry is configured to establish a joint lock of the first resource group such that access permissions of the first resource group cannot be changed by the first execution environment and the at least one other execution environment serving as soft governor of the first resource group unless the first execution environment and the at least one other execution environment serving as soft governor of the first resource group agree to change the access permissions. According to another aspect, the access control circuitry is configured to allow the first execution environment to revoke its own soft governorship of the first resource group. According to yet another aspect, the access control circuitry is configured to establish the tiered resource group access control scheme by being further configured to allow an execution environment to claim either hard governorship or soft governorship of a first resource group of the plurality of resource groups when the first resource group does not have a hard or soft governor.

According to one aspect of the disclosure, the access control circuitry includes access control logic and a plurality of resource group registers, and each resource group register of the plurality of resource groups is associated with a corresponding resource group of the plurality of resource groups. According to another aspect, the plurality of resource group registers each include a hard governor bit indicating whether the plurality of resource groups each have a hard governor. According to yet another aspect, the plurality of resource group registers each include a soft governor bit indicating whether the plurality of resource group registers have soft governors.

According to one aspect of the disclosure, the plurality of resource group registers each include a hard governor execution environment identifier field that is populated with an identifier value of a hard governor execution environment associated with the corresponding resource group of each resource group register. According to another aspect, the plurality of resource group registers each include a soft governor execution environment identifier field that is populated with at least one identifier value of at least one soft governor execution environment associated with the corresponding resource group of each resource group register. According to yet another aspect, the access control circuitry is further configured to establish the tiered resource group access control scheme where security and access control properties of a first resource group of the plurality of resource groups are managed by a first hard governor execution environment and a first soft governor execution environment, and enforce access permissions of the first resource group set by the first hard governor execution environment and the first soft governor execution environment.

Another feature provides a method operational at an electronic device, the method comprising establishing a tiered resource group access control scheme where security and access control properties of each resource group of a plurality of resource groups are managed by at least one of (a) a hard governor execution environment or at least one soft governor execution environment, the electronic device having one or more memory circuits including the plurality of resource groups, and enforcing, via access control circuitry, access permissions of each resource group of the plurality of resource groups set by at least one of (c) the hard governor execution environment or (d) the at least one soft governor execution environment of each resource group. According to one aspect, establishing the tiered resource group access control scheme includes allowing only one execution environment to claim hard governorship for each resource group of the plurality of resource groups. According to another aspect, establishing the tiered resource group access control scheme includes facilitating a hard governor execution environment of a first resource group of the plurality of resource groups to grant soft governorship of the first resource group to at least a first execution environment of the electronic device.

According to one aspect, the method further comprises facilitating the at least first execution environment having soft governorship of the first resource group to manage security and access control properties of the first resource group for execution environments of the electronic device subject to revocation of its soft governorship by the hard governor execution environment. According to another aspect, establishing the tiered resource group access control scheme includes enabling a first execution environment to claim secondary soft governorship of a first resource group of a plurality of resource groups when the first resource group has at least one other execution environment serving as its soft governor. According to yet another aspect, the method further comprises establishing a joint lock of the first resource group such that access permissions of the first resource group cannot be changed by the first execution environment and the at least one other execution environment serving as soft governor of the first resource group unless the first execution environment and the at least one other execution environment serving as soft governor of the first resource group agree to change the access permissions.

According to one aspect, the method further comprises allowing the first execution environment to revoke its own soft governorship of the first resource group. According to another aspect, establishing the tiered resource group access control scheme includes allowing an execution environment to claim either hard governorship or soft governorship of a first resource group of the plurality of resource groups when the first resource group does not have a hard or soft governor.

Another feature provides an apparatus comprising means for establishing a tiered resource group access control scheme where security and access control properties of each resource group of a plurality of resource groups are managed by at least one of (a) a hard governor execution environment or (b) at least one soft governor execution environment, the apparatus having one or more memory circuits including the plurality of resource groups, and means for enforcing access permissions of each resource group of the plurality of resource groups set by at least one of (c) the hard governor execution environment or (d) the at least one soft governor execution environment of each resource group.

Another feature provides a non-transitory computer-readable storage medium having instructions stored thereon, which when executed by at least one processor of an apparatus causes the processor to establish a tiered resource group access control scheme where security and access control properties of each resource group of a plurality of resource groups are managed by at least one of (a) a hard governor execution environment or (b) at least one soft governor execution environment, the apparatus having one or more memory circuits including the plurality of resource groups, and enforce, via access control circuitry, access permissions of each resource group of the plurality of resource groups set by (c) the hard governor execution environment or (d) the at least one soft governor execution environment of each resource group.

### BRIEF DESCRIPTION OF THE DRAWINGS

FIG. 1 illustrates a schematic block diagram of an electronic device.

FIG. 2 illustrates a multi-dimensional, hierarchical access control model featuring two trust domains each having a plurality of execution environments.

FIG. 3 illustrates a schematic block diagram of a resource access control scheme.

FIG. 4 illustrates an exemplary resource group register of the access control circuitry.

FIG. 5 illustrates a flowchart that outlines the process and rules for an execution environment to obtain hard or soft governorship of a resource group.

FIG. 6 illustrates a flowchart that outlines the process and rules for an execution environment to lose its soft governorship of a resource group.

FIG. 7 illustrates a table of rules for resource group permissions depending on whether the resource group has a hard governor or soft governors.

FIG. 8 illustrates possible values that may populate the resource group registers associated with the resource groups of FIG. 3.

FIG. 9 illustrates an exemplary flowchart of an execution environment claiming governorship of a resource group.

FIG. 10 illustrates a flow chart of a method for a resource group security and access control scheme.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, an aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

In the following description and claims, the term “coupled” may mean that two or more elements are in direct physical or electrical contact. However, “coupled” may also mean that two or more elements are not in direct contact with each other, but yet still co-operate or interact with each other. In the following description and claims, memory circuits and memory devices may be considered to each include one or more “resources.” A “resource group” is a grouping of such resources within the device or system memory map such that all resources in a group have the same security and access control properties. In some aspects, a resource group may be a physically contiguous block of memory having a minimum size. In other aspects, a resource group is not physically contiguous and may have no set standard minimum size.

In the following description and claims, a resource group may have a “governor” that has the power to manage, set, release, and otherwise control the security and access control properties of the resource group. As described in greater detail below, a resource group may have a “hard governor” and/or one or more “soft governors” whose ability to govern (i.e., power to manage, set, release, and otherwise control the security and access control properties) the resource group are subject to specific rules.

As used herein, an “execution environment” is any hardware, firmware, software, or combination thereof that has the same security and access control properties. Some non-limiting, non-exclusive examples of execution environments include user applications, higher level operating systems (HLOS), secure processors, secure memory circuits, modems, and trusted execution environments. A “trust domain” is collection of execution environments where each execution environment has its security and access control properties managed by a higher privileged execution environment in the trust domain, recursively leading to a single highest privileged execution environment (e.g., “root of trust”). Thus, each execution environment in a trust domain is directly or indirectly subject to the trust domain's root of trust.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

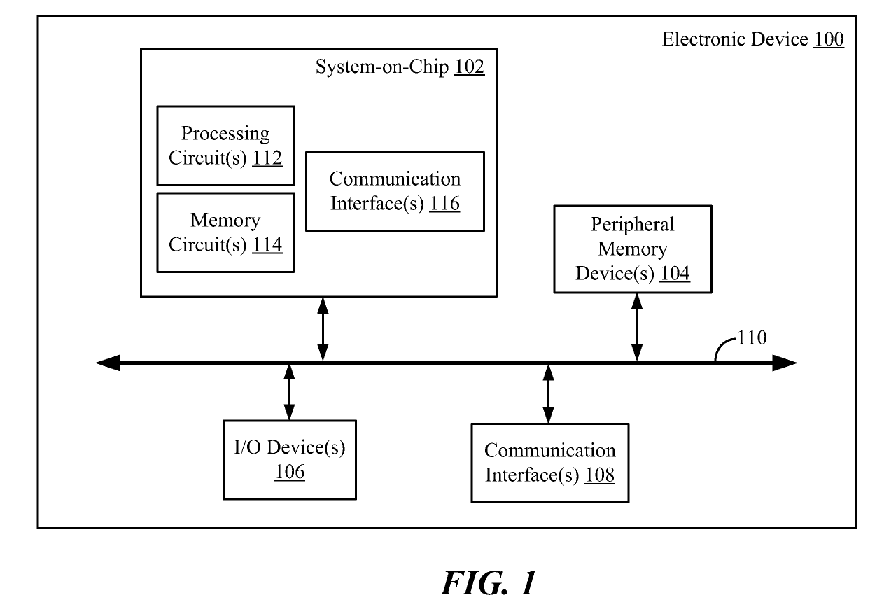

FIG. 1 illustrates a schematic block diagram of an electronic device 100 according to one aspect. The electronic device 100 may be any electronic apparatus including, but not limited to, a mobile phone, a display, a computer, a laptop, a tablet, a gaming console, a set top box, an electronic medical device, a television, or a radio. The electronic device 100 may include a system on a chip (SOC) 102, one or more peripheral memory devices 104, one or more input/output devices 106, and/or one or more communication interfaces 108. These components 102, 104, 106, 108 may be in communication with each other through a bus 110.

The one or more peripheral memory devices 104 may include volatile memory (e.g., dynamic random-access memory (DRAM), static random-access memory (SRAM), etc.), non-volatile memory (e.g., flash memory, magnetic or optical disk drives), and generally any device capable of data storage. The input/output devices 106 may include a touchscreen display, a keyboard, a mouse, a display, etc. The one or more communication interfaces 108 may include wire-line communication interfaces (USB, HDMI, Ethernet, etc.) or wireless communication interfaces (e.g., wireless wide area network (WWAN) communication interfaces, wireless local area network (WLAN) communication interfaces such as Wi-fi®, Bluetooth®, etc.).

The SOC 102 may include one or more processing circuits 112, one or more memory circuits 114, and/or one or more communication interfaces 116. The one or more processing circuits 112 may include applications processors, microcontrollers, digital signal processors, secure processors, and/or processors having more than one processing core. The one or more memory circuits 114 may include volatile memory, non-volatile memory, registers, or any other circuit on the SOC 102 capable of storing data. The SOC's processing circuits 112 may retrieve and execute code stored at the one or more on-chip memory circuits 114 and/or peripheral memory devices 104. The SOC's processing circuits 112 may generally read and write data to the one or more on-chip memory circuits 114 and/or peripheral memory devices 104 based on their access permissions.

The electronic device 100 described herein and shown in FIG. 1 is illustrated as having a SOC 102, which is a single integrated circuit (“chip”) having multiple components (e.g., digital circuits, analog circuits, mixed-signal circuits, radio frequency (RF) components, etc.). This, however, is merely one example. In other aspects, the electronic device 100 may include a system-in-package (SIP) instead of or in addition to the SOC 102. An SIP includes multiple components distributed on multiple chips, where the multiple chips are packaged together within a single package. In yet other aspects, instead of or in addition to the SOC 102, the device 100 may have multiple components distributed on multiple chips, where the multiple chips are packaged within multiple packages and interconnected through a printed circuit board. Consequently, when referring to the device's “SOC 102,” it should be understood that the scope of the present disclosure extends to electronic devices having SIPs and/or multiple-package electronic systems.

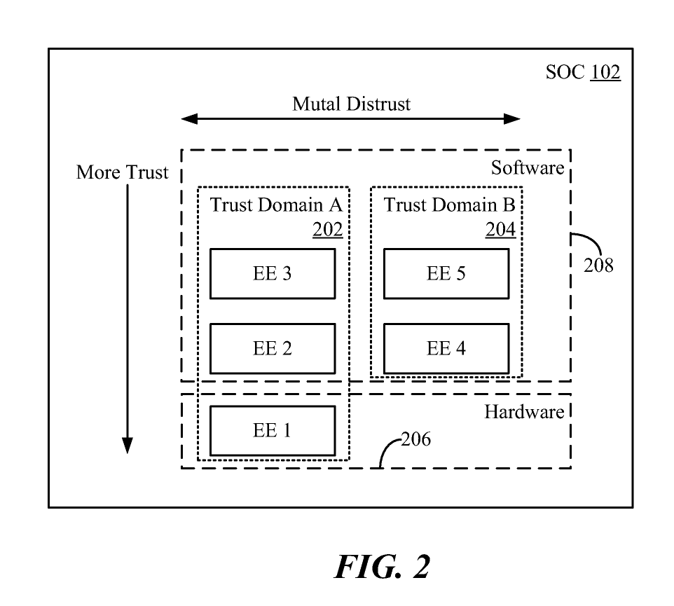

The SOC 102 may host a plurality of execution environments (EEs) associated with different trust domains. For example, FIG. 2 illustrates a multi-dimensional, hierarchical access control model featuring two trust domains 202, 204 each having a plurality of execution environments. Trust Domain A 202 includes three execution environments denoted EE 1, EE 2, and EE 3, while Trust Domain B 204 includes two execution environments EE 4 and EE 5. EE 3 has its security and access control properties managed by the higher privileged (i.e., more trusted) EE 2, which in turn has its security and access control properties managed by the highest privileged execution environment, EE 1, which serves as a root of trust for Trust Domain A 202. In the example shown, EE 1 is a hardware element 206.

Similarly, Trust Domain B's EE 5 has its security and access control properties managed by the higher privileged EE 4, which serves as the root of trust for Trust Domain B 204. In contrast to EE 1, Trust Domain B's root of trust EE 4 is a software element 208. Generally, the execution environments EE 1, EE 2, and EE 3 of Trust Domain A 202 do not inherently trust the execution environments EE 4 and EE 5 of Trust Domain B 204 since they have different roots of trust. However, the resource group access control policies described in greater detail below enable different execution environments (e.g., EE 1, EE2, EE3, EE4, and EE 5) belonging to different trust domains (e.g., Trust Domain A and B) to manage the access control policies of execution environments not associated with their own trust domain under a flexible, tiered (e.g., two-tiered) resource group governorship scheme.

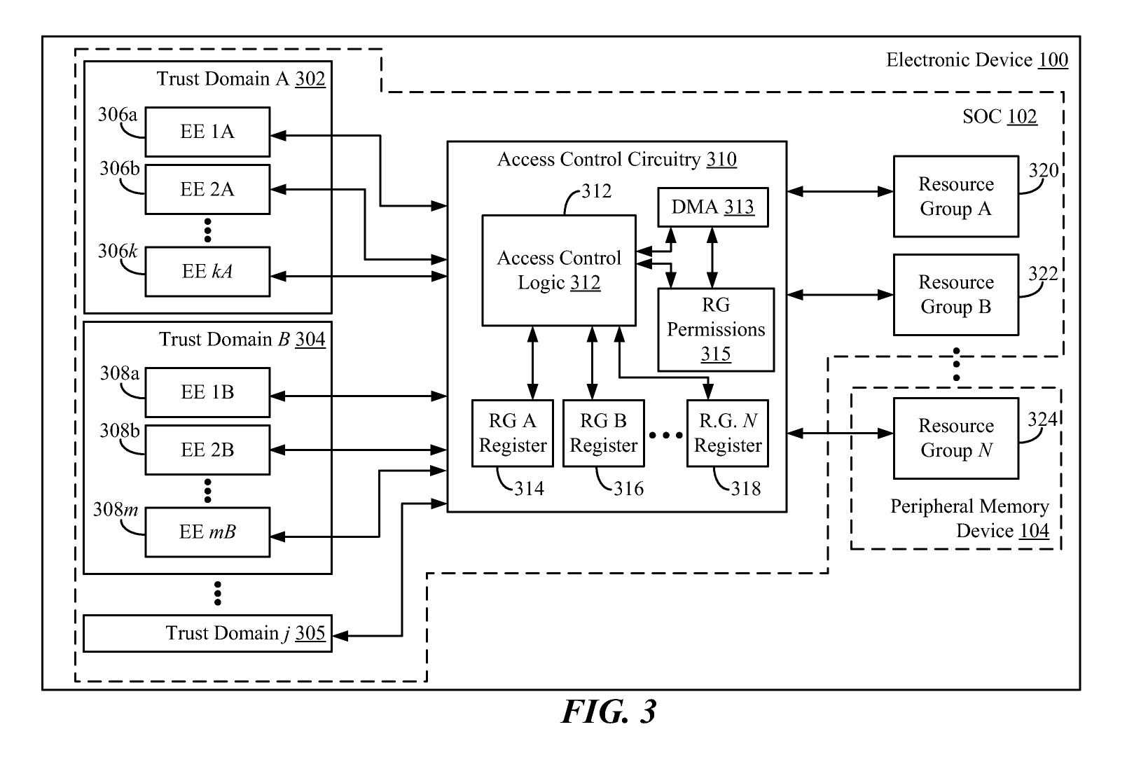

FIG. 3 illustrates a schematic block diagram of a resource access control scheme according to one aspect. The electronic device's SOC 102 may host j number of trust domains 302, 304, 305, each associated with one or more execution environments 306a, 306b, . . . 306k, 308a, 308b, . . . 308m (collectively referred to herein as “306a-k” and “308a-m”), where j, k, and m are all integer values equal to or greater than one (1). The SOC 102 may also include access control circuitry 310 having access control logic 312, a direct memory access (DMA) circuit 313, a resource group permissions circuit/module 315, and n number of resource group (RG) registers 314, 316, . . . 318, where n is an integer value equal to or greater than one (1). The electronic device 100 may include n number of resource groups 320, 322, . . . 324 (n is an integer value equal to or greater than one (1)), some of which may be resident to the SOC 102 and some of which may be resident to a peripheral memory device(s) 104. Each resource group 320, 322, . . . , 324 may have a corresponding resource group register 314, 316, . . . 318. In the example shown in FIG. 3, resource groups A and B 320, 322 are resident to the SOC 102 while resource group N 324 is resident to a peripheral memory device 104.

The access control logic 312 and resource group registers 314, 316, . . . 318 enable the execution environments 306a-k, 308a-m to claim governorship of the resource groups 320, 322, . . . 324 and also enforce established access control policies of the resource groups 320, 322, . . . 324. Specifically, the access control logic 312 and resource group registers 314, 316, . . . 318 implement a tiered governorship access control scheme (e.g., two-tiered governorship access control scheme) where execution environments 306a-k, 308a-m may either take “hard” governorship or “soft” governorship of a resource group 320, 322, . . . 324. The rights, privileges, and limitations of an execution environment having hard governorship or soft governorship of a resource group is explained in greater detail below. Other modules of the access control circuitry 310, such as the DMA circuit 313, may be tasked with reading data from and writing data to the resource groups 320, 322, . . . 324 on behalf of the execution environments 306a-k, 308a-m. The resource group permissions circuit 315 may store the access permissions of all EEs 306a-k, 308a-m for all resource groups 320, 322, . . . 324.

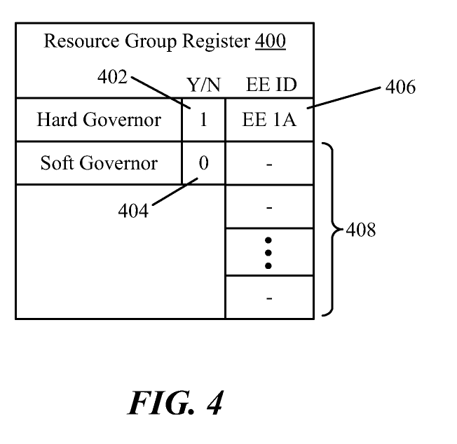

FIG. 4 illustrates an exemplary resource group register 400 of the access control circuitry 310 according to one aspect of the disclosure. The resource group register 400 may include a hard governor bit 402, a soft governor bit 404, a hard governor EE identifier (ID) 406, and one or more soft governor EE IDs 408. The hard governor bit 402 indicates whether the resource group associated with the RG register 400 currently has an execution environment serving as a hard governor. In the example shown, “1” indicates that it does have a hard governor while a “0” indicates that it does not. The soft governor bit 404 indicates whether the resource group associated with the RG register 400 currently has an execution environment serving as one or more soft governors. In the example shown, “1” indicates that it does have one or more soft governors while a “0” indicates that it does not have any soft governors.

The hard governor EE ID 406 is a register that includes an identifier associated with the execution environment of the resource group's hard governor, assuming the resource group has one. The soft governor EE ID 408 are registers that include identifiers associated with the execution environments of the resource group's one or more soft governors, assuming the resource group has any.

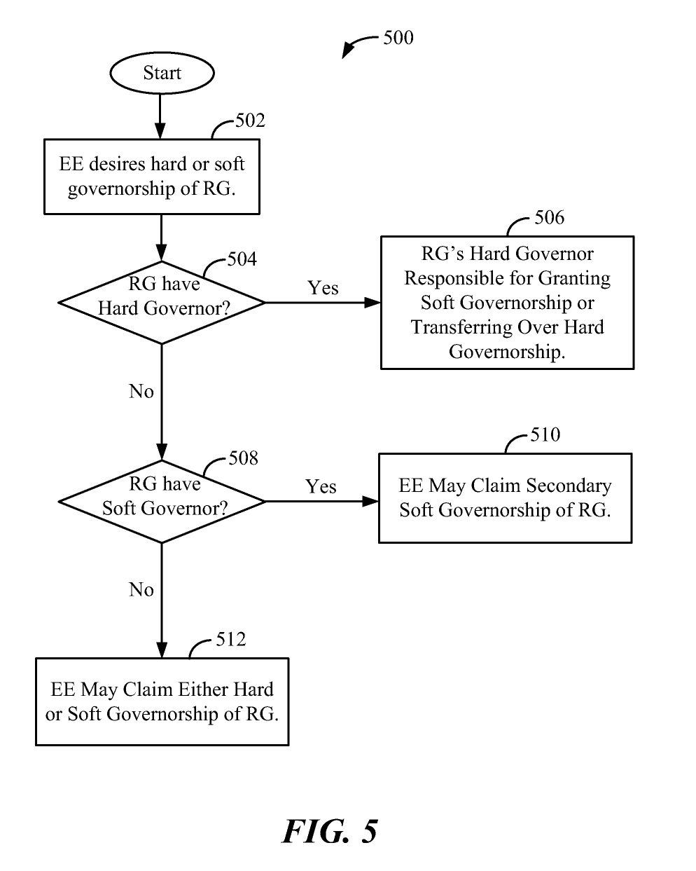

FIG. 5 illustrates a flowchart 500 that outlines the process and rules for an execution environment to obtain hard or soft governorship of a resource group according to one aspect of the disclosure. The process and rules may be carried out or otherwise enforced by the access control circuit 310 shown in FIG. 3.

Referring to FIG. 5, an execution environment may desire to claim 502 hard or soft governorship of a resource group. Before it may do so, it may be determined 504 whether the resource group already has a hard governor. If the resource group already has a hard governor, then in some aspects of the disclosure the execution environment cannot claim hard or soft governorship of the resource group by itself. Instead, the resource group's existing hard governor may grant 506 soft governorship to the requesting execution environment or it may transfer over its own hard governorship of the resource group to the requesting execution environment. In the event the hard governor transfers over its hard governorship of the resource group to a target execution environment (e.g., requesting EE), the transfer may take place in a single transaction spanning a single clock cycle so that there is no gap in or overlap in hard governorship of the resource group.

In the event the resource group does not have a hard governor, then it may be determined 508 whether the resource group has a soft governor. If the resource group has at least one soft governor, then the execution environment may itself claim 510 secondary soft governorship of the resource group. In some aspects, an execution environment having secondary soft governorship has the same rights and privileges as a soft governor that an execution environment has that claimed soft governorship first. Thus, a resource group may have a plurality (two or more) soft governors all having equal rights. In the event the resource group does not have a soft governor or a hard governor, then the execution environment may itself claim 512 either hard governorship or soft governorship.

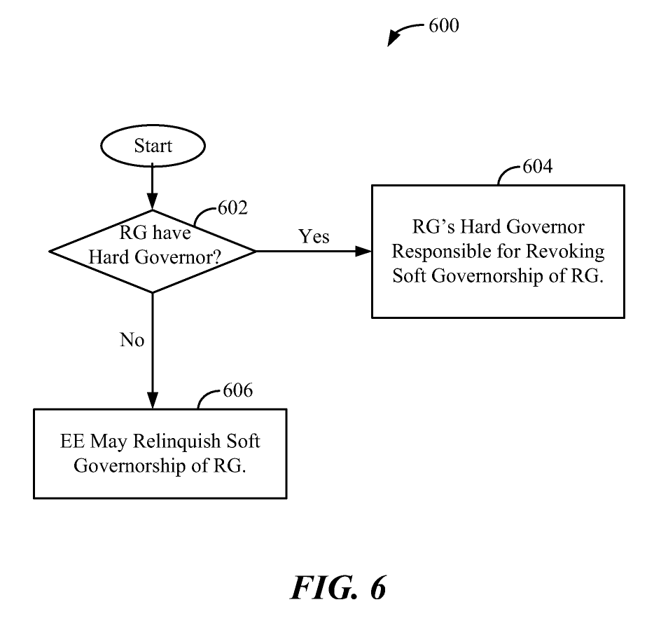

FIG. 6 illustrates a flowchart 600 that outlines the process and rules for an execution environment to lose its soft governorship of a resource group according to one aspect of the disclosure. The process and rules may be carried out or otherwise enforced by the access control circuit 310 shown in FIG. 3.

Referring to FIG. 6, it may be determined 602 whether the resource group has a hard governor. If the resource group has a hard governor, then in some aspects of the disclosure the execution environment cannot revoke/relinquish its soft governorship of the resource group by itself. Instead, the resource group's existing hard governor may revoke 604 the execution environment's soft governorship. The hard governor may revoke the soft governor's soft governorship without the soft governor's consent. If the resource group does not have a hard governor, then the execution environment may relinquish 606 its own soft governorship of the resource group. In some aspects of the disclosure, a soft governor may relinquish its soft governorship on its own volition even if the underlying resource group has a hard governor. In such cases, the soft governor may relinquish its soft governorship without intervention or approval by the hard governor.

Moreover, soft governorship may also be effectively transferred from one EE to another EE without a gap in governorship of a resource. For example, after a second EE claims secondary soft governorship of a resource group, the first soft governor may revoke its own soft governorship leaving only one soft governor of the resource group. This process effectively results in the transfer of soft governorship of the resource group without a gap in governorship.

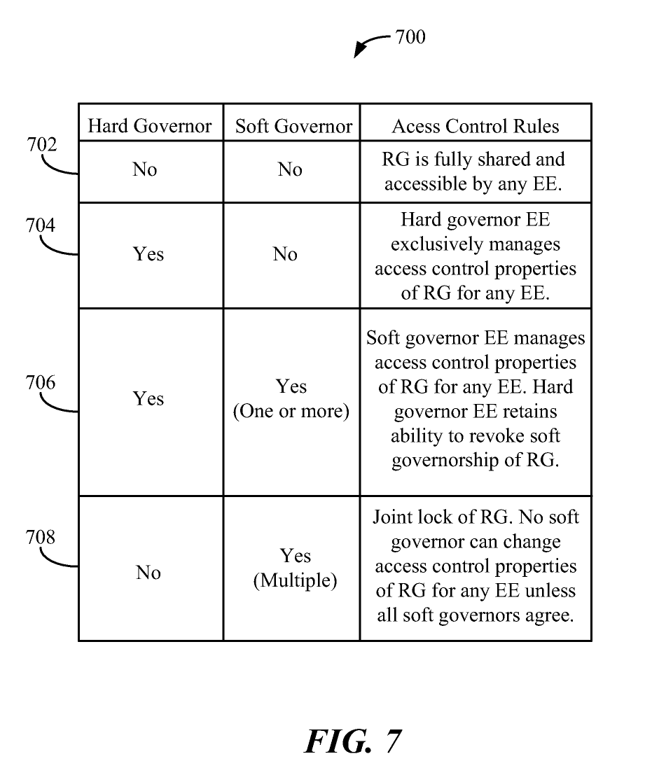

FIG. 7 illustrates a table 700 of rules for resource group permissions depending on whether the resource group has a hard governor and/or soft governors according to one aspect. In the case where a resource group does not have a hard or a soft governor 702, the resource group may be shared and may be fully accessible (read and write) by all execution environments. In the case where a resource group has a hard governor but no soft governor 704, then the hard governor execution environment exclusively manages the security and access control properties of the resource group for all execution environments. In the case where a resource group has a hard governor and one or more soft governors 706, then the soft governor(s) may manage the security and access control properties of the resource group for all execution environments including the hard governor of the resource group. However, in this case the hard governor has the ability to revoke the soft governorship(s) of the resource group. The hard governor may also have the ability to override the soft governor(s) management of the resource group by managing the security and access control properties of the resource group for all execution environments itself. In the case where a resource group has no hard governor but has multiple soft governors 708, then the plurality of soft governors all share the resource group under a joint lock scheme where no soft governor may change the security and access control properties of the resource group for any execution environment. In some aspects of the disclosure, under the joint lock scheme no individual soft governor may alone change the security and access control properties of the resource group for any execution environment unless all the soft governors agree to make the change. In such a case, the access control circuitry 310 may use a voting mechanism with aggregation in hardware to determine whether the soft governors all agree to a change.

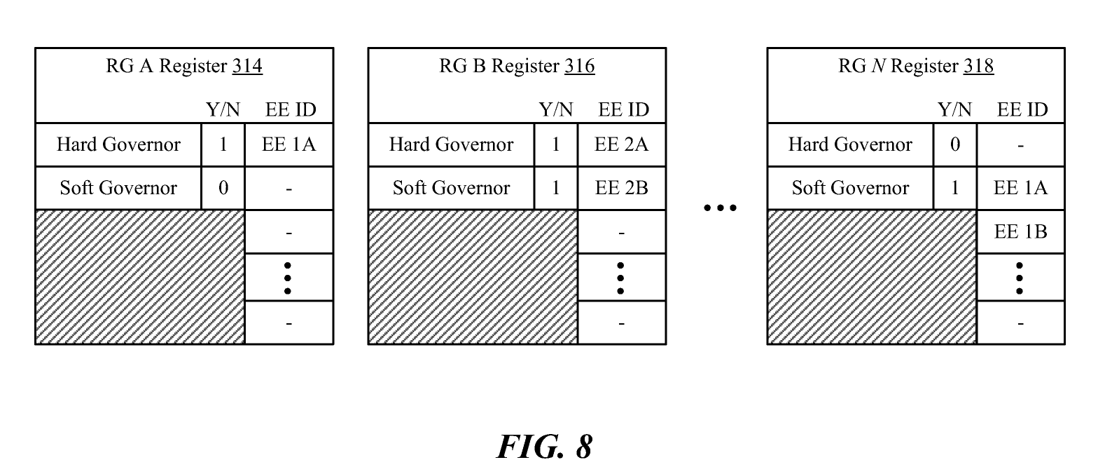

FIG. 8 illustrates possible values that may populate the resource group registers 314, 316, . . . 318 associated with the resource groups 320, 322, . . . 324 of FIG. 3 according to one aspect. Referring to FIGS. 3, 5, 7, and 8, EE 1A 306a may be the hard governor of resource group A 320. As such, resource group A register's 314 hard governor bit may store a “1” to reflect that resource group A 320 has a hard governor, and its hard governor execution environment identifier field may be populated with an ID value associated with EE 1A 306a. Since resource group A 320 does not have a soft governor, resource group A register's soft governor bit may store a “0” and its soft governor execution environment identifier fields may be null.

As the hard governor of resource group A 320, EE 1A 306a exclusively manages security and access control properties of resource group A 320 for all EEs 306a-k, 308a-m. For instance, EE 1A 306a may decide that EE 2A 306b has read/write access permissions to resource group A 320, EE 1B 308a has read only permission to resource group A 320, and all other EEs 306k, 308b, . . . 308m have no access to resource group A 320. These access permissions may be stored at the resource group permissions circuit 315. If another execution environment, such as EE 2A 306b or EE 1B 308a, were to try and claim governorship of resource group A 320, the access control circuitry 310 (e.g., access control logic 312) would prevent them from doing so. As the hard governor, EE 1A 306a would decide whether to grant EE 2A 306b or EE 1B 308a soft governorship or to transfer its hard governorship to one of them so that they could instead manage the security and access control properties of all the execution environments of the device 100.

Similarly, EE 2A 306b may be the hard governor of resource group B 322 and EE 2B 308b may be the soft governor of resource group B 322. As such, resource group B register's 316 hard governor bit may store a “1” to reflect that resource group B 322 has a hard governor, and its hard governor execution environment identifier field may be populated with an ID value associated with EE 2A 306b. Resource group B register's 316 soft governor bit may also store a “1” to reflect that resource group B 322 has a soft governor, and its soft governor execution environment identifier field may be populated with an ID value associated with EE 2B 308b.

As the hard governor of resource group B 322, EE 2A 306b granted EE 2B 308b soft governorship of resource group B 322 allowing EE 2B 308b to manage security and access control properties of resource group B 322 for all EEs 306a-k, 308a-m as if it were the sole governor. (Note, however, that according to one aspect of the disclosure, the hard governor EE 2A 306b may still retain the ability to manage security and access control properties of resource group B 322 for all EEs 306a-k, 308a-m alongside the soft governor EE 2B 308b.) In this fashion, the hard governor delegates its governorship responsibilities, including the power to manage, set, release, and otherwise control the security and access control properties of the resource group, to the soft governor. For instance, EE 2B 308b may decide that EE 1A 306a has read/write access permissions to resource group B 322 and EE 1B 308a has read only permission to resource group B 322. These access permissions may be stored at the resource group permissions circuit 315. If another execution environment, such as EE 1A 306a or EE 1B 308a, were to try and claim governorship of resource group B 322, the access control circuitry 310 (e.g., access control logic 312) would prevent them from doing so. As the hard governor, EE 2A 306b would decide whether to revoke EE 2B's 308b soft governorship and grant EE 1A 306a or EE 1B 308a soft governorship or to transfer its hard governorship to one of them so that they could instead manage the security and access control properties of all the execution environments of the device 100.

Resource group N 324, however, may not have a hard governor. Consequently, resource group N register's hard governor bit may be “0” and its hard governor execution environment ID field may be unpopulated. That said, according to the example shown, resource group N 324 has two soft governors, EE 1A 306a and EE 1B 308a. As such, resource group N register's soft governor bit may be a “1” and its soft governor EE ID fields are populated with the ID values of EE 1A 306a and EE 1B 308a. Prior to EE 1B 308a claiming secondary soft governorship, EE 1A 306a was free to change the security and access control properties of all EEs 306a-k, 308a-m for resource group N 324. However, after EE 1B 308a claimed secondary soft governorship, resource group N 324 became subject to joint lock, and thus the security and access control properties of all EEs 306a-k, 308a-m for resource group N 324 remain fixed/locked with whatever privileges and permissions were set prior to EE 1B 308a claiming secondary soft governorship. The EEs' 306a-k, 308a-m security and access control properties may be changed only if both soft governors EE 1A 306a and EE 1B 308a agree to the change.

For example, prior to EE 1B 308a claiming secondary soft governorship of resource group N 324, EE 1A 306a may have set read/write access permissions of resource group N 324 for EE 1A 306a and set no access permissions (i.e., no right to access) for all other EEs 306b, . . . 306k, 308a-m. These access permissions may be stored at the resource group permissions circuit 315. EE 1B 308a may then verify resource group N's 324 access permissions (e.g., ensuring that the current access permissions are to its liking) and claim soft governorship resulting in resource group N 324 having two soft governors. Upon claiming secondary soft governorship, access permissions of resource group N 324 is locked and thus EE 1A's 306 read/write access permissions remains in effect and other EEs 306b, . . . 306k, 308a-m may not access resource group N 324. In some aspects, these security and access control properties may be changed for the EEs 306a-k, 308a-m if both EE 1A 306a and EE 1B 308a agree. In other aspects, the security and access control properties of the resource group may not be changed as long as there is more than one soft governor and no hard governor.

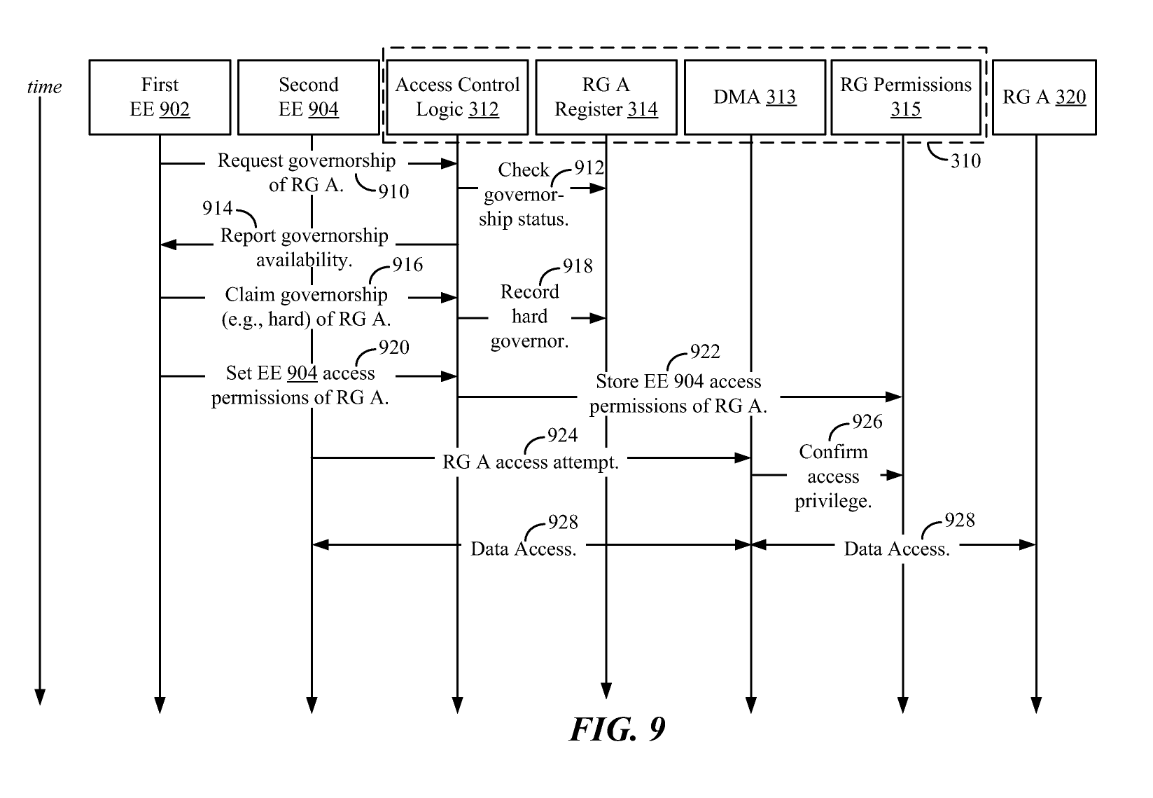

FIG. 9 illustrates an exemplary flowchart of an execution environment claiming governorship (e.g., hard) of a resource group according to one aspect. A first execution environment 902 may desire to take control of the security and access control properties of resource group A 320 by claiming governorship of the resource group. The EE 902 may first send 910 a request to claim governorship of the resource to the access control logic 312. The access control logic 312 may then check 912 the resource group A register 314 associated with resource group A 320 to determine whether resource group A 320 has a hard or soft governor already.

The access control logic 312 may then report 914 its findings and governorship availability back to the requesting EE 902. In the example shown, it is presumed that RG A 320 does not have a hard or soft governor and thus the first EE 902 claims 916 hard governorship of the resource group 320. The access control logic 312 records 918 resource group A's 320 updated hard governorship status (e.g., updates its hard governor bit to “1” and stores the first EE's 902 ID) at the resource group register 314. The first EE 902 is then free to manage the security and access control properties of resource group A 320 for all EEs. In the example shown, the first EE 902 decides to grant 920 a second EE 904 read/write access permissions to resource group A 320. These access permissions may be stored 922 at the resource group permissions circuit 315. The second EE 904 may then attempt to access 924 data stored at resource group A 320. Such data access requests may be handled by the DMA 313. The DMA 313 may check/confirm 926 with the resource group permissions circuit 315 that the second EE 904 has the appropriate access permission requested. Assuming the second EE 904 does, the DMA 313 may facilitate data access 928 between the second EE 904 and the resource group 320.

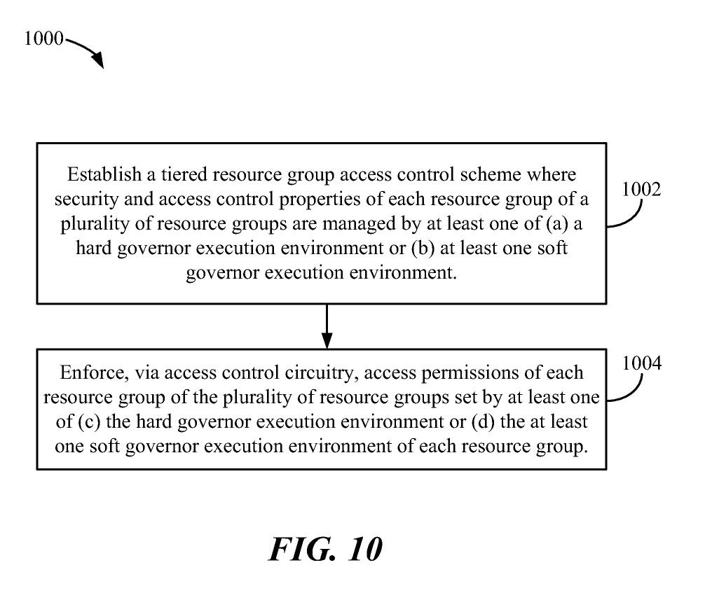

FIG. 10 illustrates a flow chart 1000 of a method for a resource group security and access control scheme according to one aspect. The method includes establishing 1002 a tiered resource group access control scheme where security and access control properties of each resource group of a plurality of resource groups are managed by a hard governor execution environment and/or at least one soft governor execution environment. Next access control circuitry may enforce 1004 access permissions of each resource group of the plurality of resource groups set by the hard governor execution environment and/or the at least one soft governor execution environment of each resource group.

Referring to FIG. 3, the access control circuit 310, including its access control logic 312, resource group registers 314, 316, . . . 318, DMA 313, and resource group permissions circuit 315, may all be specialized circuitry that are specially designed to carry out the flexible, tiered (e.g., two-tiered including hard and soft governorship) resource group access control scheme described herein. Thus, the access control circuit 310, including its access control logic 312, resource group registers 314, 316, . . . 318, DMA 313, and resource group permissions circuit 315, may be one non-limiting, non-exclusive example of a means for establishing a tiered resource group access control scheme where security and access control properties of each resource group of a plurality of resource groups are managed by a hard governor execution environment and/or at least one soft governor execution environment. The access control circuit 310, including its access control logic 312, resource group registers 314, 316, . . . 318, DMA 313, and resource group permissions circuit 315, may also be one non-limiting, non-exclusive example of a means for enforcing access permissions of each resource group of the plurality of resource groups set by the hard governor execution environment and/or the at least one soft governor execution environment of each resource group.

Such an access control scheme and the circuitry and any associated software therewith may help improve the operation and functionality of the underlying electronic device 100 in significant ways. For example, speed of the electronic device 100 may be improved because the access control scheme and its associated circuitry and software enable the electronic device 100 to utilize its physical memory more efficiently by allowing execution environments belonging to different trust domains to manage resource groups' security and access control properties for all execution environments based on the tiered, hard/soft governorship scheme.

As another example, the underlying electronic device 100 may feature increased flexibility since it enables a manufacturer to define different trust models at boot time using the same hardware. For instance, in one version different execution environments may be part of the same trust domain whereas in other versions the same execution environments may be parts of different trust domains.

In yet another example of improved operation and functionality, the resource group access control schemes described herein may improve the security of the underlying electronic device 100 because such schemes implemented, at least in part, in hardware allow for horizontal trust models (e.g., several mutually distrusted roots of trust) that have a commonly trusted hardware component.

One or more of the components, steps, features, and/or functions illustrated in FIGS. 1, 2, 3, 4, 5, 6, 7, 8, 9, and/or 10 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1, 2, 3, 4, 8, and/or 9 may be configured to perform one or more of the methods, features, or steps described in FIGS. 5, 6, 7, 9, and/or 10. One or more of the algorithms described herein may be efficiently implemented in software and/or embedded in hardware.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing or containing instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. An apparatus comprising:
one or more memory circuits including a plurality of resource groups;
access control circuitry communicatively coupled to the one or more memory circuits, the access control circuitry configured to:
establish a tiered resource group access control scheme where security and access control properties of each resource group of the plurality of resource groups are managed by at least one of (a) a hard governor execution environment or (b) at least one soft governor execution environment; and
enforce access permissions of each resource group of the plurality of resource groups set by at least one of (c) the hard governor execution environment or (d) the at least one soft governor execution environment of each resource group.

2. The apparatus of claim 1, wherein the access control circuitry is configured to establish the tiered resource group access control scheme by being further configured to:
allow only one execution environment to claim hard governorship for each resource group of the plurality of resource groups.

3. The apparatus of claim 2, wherein an execution environment having hard governorship of a first resource group of the plurality of resource groups exclusively manages security and access control properties of the first resource group for execution environments of the apparatus.

4. The apparatus of claim 1, wherein the access control circuitry is configured to establish the tiered resource group access control scheme by being further configured to:
facilitate a hard governor execution environment of a first resource group of the plurality of resource groups to grant soft governorship of the first resource group to at least a first execution environment of the apparatus.

5. The apparatus of claim 4, wherein the access control circuitry is further configured to:
facilitate the at least first execution environment having soft governorship of the first resource group to manage security and access control properties of the first resource group for execution environments of the apparatus subject to revocation of its soft governorship by the hard governor execution environment.

6. The apparatus of claim 1, wherein the access control circuitry is configured to establish the tiered resource group access control scheme by being further configured to:
enable a first execution environment to claim secondary soft governorship of a first resource group of a plurality of resource groups when the first resource group has at least one other execution environment serving as its soft governor.

7. The apparatus of claim 6, wherein the access control circuitry is configured to:
establish a joint lock of the first resource group such that access permissions of the first resource group cannot be changed by the first execution environment and the at least one other execution environment serving as soft governor of the first resource group unless the first execution environment and the at least one other execution environment serving as soft governor of the first resource group agree to change the access permissions.

8. The apparatus of claim 6, wherein the access control circuitry is configured to:
allow the first execution environment to revoke its own soft governorship of the first resource group.

9. The apparatus of claim 1, wherein the access control circuitry is configured to establish the tiered resource group access control scheme by being further configured to:
allow an execution environment to claim either hard governorship or soft governorship of a first resource group of the plurality of resource groups when the first resource group does not have a hard or soft governor.

10. The apparatus of claim 1, wherein the access control circuitry includes access control logic and a plurality of resource group registers, and each resource group register of the plurality of resource groups is associated with a corresponding resource group of the plurality of resource groups.

11. The apparatus of claim 10, wherein the plurality of resource group registers each include a hard governor bit indicating whether the plurality of resource groups each have a hard governor.

12. The apparatus of claim 10, wherein the plurality of resource group registers each include a soft governor bit indicating whether the plurality of resource group registers have soft governors.

13. The apparatus of claim 10, wherein the plurality of resource group registers each include a hard governor execution environment identifier field that is populated with an identifier value of a hard governor execution environment associated with the corresponding resource group of each resource group register.

14. The apparatus of claim 10, wherein the plurality of resource group registers each include a soft governor execution environment identifier field that is populated with at least one identifier value of at least one soft governor execution environment associated with the corresponding resource group of each resource group register.

15. The apparatus of claim 1, wherein the access control circuitry is further configured to:
establish the tiered resource group access control scheme where security and access control properties of a first resource group of the plurality of resource groups are managed by a first hard governor execution environment and a first soft governor execution environment; and
enforce access permissions of the first resource group set by the first hard governor execution environment and the first soft governor execution environment.

16. A method operational at an electronic device, the method comprising:
establishing a tiered resource group access control scheme where security and access control properties of each resource group of a plurality of resource groups are managed by at least one of (a) a hard governor execution environment or (b) at least one soft governor execution environment, the electronic device having one or more memory circuits including the plurality of resource groups; and
enforcing, via access control circuitry, access permissions of each resource group of the plurality of resource groups set by at least one of (c) the hard governor execution environment or (d) the at least one soft governor execution environment of each resource group.

17. The method of claim 16, wherein establishing the tiered resource group access control scheme includes:
allowing only one execution environment to claim hard governorship for each resource group of the plurality of resource groups.

18. The method of claim 17, wherein an execution environment having hard governorship of a first resource group of the plurality of resource groups exclusively manages security and access control properties of the first resource group for execution environments of the electronic device.

19. The method of claim 16, wherein establishing the tiered resource group access control scheme includes:
facilitating a hard governor execution environment of a first resource group of the plurality of resource groups to grant soft governorship of the first resource group to at least a first execution environment of the electronic device.

20. The method of claim 19, the method further comprising:
facilitating the at least first execution environment having soft governorship of the first resource group to manage security and access control properties of the first resource group for execution environments of the electronic device subject to revocation of its soft governorship by the hard governor execution environment.

21. The method of claim 16, wherein establishing the tiered resource group access control scheme includes:
enabling a first execution environment to claim secondary soft governorship of a first resource group of a plurality of resource groups when the first resource group has at least one other execution environment serving as its soft governor.

22. The method of claim 21, the method further comprising:
establishing a joint lock of the first resource group such that access permissions of the first resource group cannot be changed by the first execution environment and the at least one other execution environment serving as soft governor of the first resource group unless the first execution environment and the at least one other execution environment serving as soft governor of the first resource group agree to change the access permissions.

23. The method of claim 21, the method further comprising:
allowing the first execution environment to revoke its own soft governorship of the first resource group.

24. The method of claim 16, wherein establishing the tiered resource group access control scheme includes:
allowing an execution environment to claim either hard governorship or soft governorship of a first resource group of the plurality of resource groups when the first resource group does not have a hard or soft governor.

25. The method of claim 16, wherein the access control circuitry includes access control logic and a plurality of resource group registers, and each resource group register of the plurality of resource groups is associated with a corresponding resource group of the plurality of resource groups.

26. The method of claim 25, wherein the plurality of resource group registers each include a hard governor bit indicating whether the plurality of resource groups each have a hard governor.

27. The method of claim 25, wherein the plurality of resource group registers each include a soft governor bit indicating whether the plurality of resource group registers have soft governors.

28. The method of claim 25, wherein the plurality of resource group registers each include a hard governor execution environment identifier field that is populated with an identifier value of a hard governor execution environment associated with the corresponding resource group of each resource group register.

29. An apparatus comprising:
means for establishing a tiered resource group access control scheme where security and access control properties of each resource group of a plurality of resource groups are managed by at least one of (a) a hard governor execution environment or (b) at least one soft governor execution environment, the apparatus having one or more memory circuits including the plurality of resource groups; and
means for enforcing access permissions of each resource group of the plurality of resource groups set by at least one of (c) the hard governor execution environment or (d) the at least one soft governor execution environment of each resource group.

30. A non-transitory computer-readable storage medium having instructions stored thereon, which when executed by at least one processor of an apparatus causes the processor to:
establish a tiered resource group access control scheme where security and access control properties of each resource group of a plurality of resource groups are managed by at least one of (a) a hard governor execution environment or (b) at least one soft governor execution environment, the apparatus having one or more memory circuits including the plurality of resource groups; and
enforce, via access control circuitry, access permissions of each resource group of the plurality of resource groups set by at least one of (c) the hard governor execution environment or (d) the at least one soft governor execution environment of each resource group.
